(19) United States
(12) Patent Application Publication
(10) Pub. No.: US 2010/0034923 A1
(43) Pub. Date: Feb. 11, 2010

(54) ENHANCING THE EFFECTIVE CONCENTRATION OF LYSOZYME IN WINE

(76) Inventors: Mark A. Daeschel, Philomath, OR (US); James A. Kennedy, Corvallis, OR (US)

Correspondence Address: KLARQUIST SPARKMAN, LLP, 121 SW SALMON STREET, SUITE 1600, PORTLAND, OR, 97204, US

(21) Appl. No.: 11/993,789

(22) PCT Filed: Jun. 16, 2006
(86) PCT No.: PCT/US06/23581

§ 371 Date: Dec. 21, 2007

Related U.S. Application Data
(60) Provisional application No. 60/692,845, filed on Jun. 21, 2005.

(51) Int. Cl. C12G 1/00; C12G 1/02

(52) U.S. Cl. 426/12

(57) ABSTRACT

The present disclosure provides methods that decrease the interaction between tannins found in wine (such as polymeric tannins) and lysozyme added to wine as an antimicrobial agent, for example by adding a tannin-binding agent to the wine prior to adding lysozyme to the wine. In particular examples, such methods increase lysozyme antimicrobial activity (for example by increasing the effective lysozyme concentration) in the wine, since lysozyme bound to tannin is not available for providing antimicrobial activity. Also provided are methods for making wine. Compositions that include wine, lysozyme, and one or more tannin-binding agents that decrease the interaction between tannins and lysozyme are also disclosed.

### CROSS REFERENCE TO RELATED APPLICATION

This application claims the benefit of U.S. Provisional Application No. 60/692,845 filed Jun. 21, 2005, herein incorporated by reference.

### FIELD

The present disclosure relates to compositions that include wine and lysozyme.

### BACKGROUND

In winemaking it is desirable to control or eliminate bacteria that may spoil wine. For example the presence of bacteria can result in the production of off flavors, off aromas, loss of texture, and haze formation. Moreover, certain bacteria, through the production of volatile acids, make wine adulterated and thus illegal to sell.

There are a variety of antimicrobial agents that are permitted for use in wine to control bacterial spoilage, such as lysozyme and sulfur dioxide. Recently the use of hen egg white lysozyme as an antimicrobial in wine has gained favor with wine makers as an additive for controlling bacterial spoilage. As compared to sulfur dioxide, lysozyme is active only against spoilage bacteria, does not effect the growth of fermentation yeast, and is not dependent on pH.

However, the antimicrobial action of lysozyme can be influenced by its interaction with wine components. The effects of such an interaction can result in the production of a lysozyme-precipitate in wine, which is unavailable for antimicrobial activity. As a result, lysozyme is added to wine at concentrations higher than is theoretically needed in order to ensure that sufficient residual antimicrobial activity is available.

Because of the formation of complexes between lysozyme and wine components, the use of lysozyme in winemaking has been limited to certain critical spoilage situations that require its antimicrobial action to eliminate bacteria. One example is when an active yeast fermentation terminates with sugar remaining. Bacteria can then use the sugar and spoil the wine. One method used to remedy the problem is to add yeast nutrients or new yeast. However, until the yeast start to ferment again there is a strong likelihood that contaminating bacteria will begin to grow and spoil the wine. Sulfur dioxide is contraindicated because it may slow or prevent the yeast from restarting the fermentation. Lysozyme has been successfully used is this situation because of its specific action against bacteria and does not significantly compromise yeast performance.

To expand the commercial application and use of lysozyme in the winemaking industry, methods are needed to reduce the interaction between lysozyme and wine components.

### SUMMARY

The inventors have observed that lysozyme interacts with polymeric tannins in wine, and that addition of a tannin-binding agent to wine, such as pectin, prior to addition of lysozyme to the wine, results in decreased precipitation of lysozyme, and increased availability of lysozyme for antimicrobial activity. This increases the effective concentration of lysozyme in the wine. Based on these observations, methods are provided for decreasing an interaction between tannin (such as polymeric tannin) and lysozyme. In particular examples, the method includes introducing or adding one or more tannin-binding agents into wine (such as one tannin-binding agent, two tannin-binding agents, or three tannin-binding agents) under conditions sufficient to permit the tannin-binding agent to bind to (for example form a complex with) tannins present in the wine. The resulting interaction between the tannin-binding agent and tannins can decrease the interaction between tannin and lysozyme added to the wine as an antimicrobial. The method can also include introducing or adding lysozyme into the wine, for example at a time subsequent to adding the tannin-binding agent into the wine.

In particular examples, the one or more tannin-binding agents are introduced in an amount sufficient that the interaction between the tannin and the lysozyme is decreased, for example by at least 50% as compared to interaction in the absence of the tannin-binding agent.

In particular examples, decreasing the interaction between tannin and lysozyme increases the lysozyme antimicrobial activity in the wine, as compared to the lysozyme antimicrobial activity in the absence of the tannin-binding agent. For example, decreasing the interaction between tannin and lysozyme can increase the amount of free lysozyme available for antimicrobial activity, such as by decreasing precipitation of added lysozyme. In particular examples, this increases the effective concentration of lysozyme in the wine. As a result, less lysozyme needs to be added to the wine to achieve the same amount of antimicrobial activity than would be needed in the absence of one or more tannin-binding agents.

In another example, decreasing the interaction between tannin and lysozyme decreases wine color and texture loss, for example a decrease of at least 20% as compared to interaction in the absence of the tannin-binding agent.

Particular examples of tannin-binding agents include, but are not limited to, polysaccharides (such as pectin, starch, chitin, cellulose, guar gum, or gum arabic, glycogen), proteins (such as gelatin), carbohydrates, or combinations thereof.

The present disclosure also provides methods of enhancing the effective concentration of lysozyme in wine. In particular examples, the method includes adding one or more tannin-binding agents into the wine under conditions sufficient for binding of the tannin-binding agent(s) to the tannins present in the wine, and then adding lysozyme to the wine.

Also provided by the present disclosure are methods of producing wine. For example the method of producing wine can include introducing one or more tannin-binding agents to the wine under conditions sufficient for binding of the tannin-binding agent to tannin in the wine, and also introducing lysozyme to the wine. In a particular example, the method of producing wine includes producing a must, then fermenting the must to generate wine that includes tannins. After the fermentation, one or more tannin-binding agents are added into the wine under conditions sufficient to permit interaction between the tannin-binding agent and tannins in the wine. After the tannin-binding agents and tannins have interacted (for example the tannin-binding agents have substantially masked the binding sites on tannin that interact with lysozyme), lysozyme is added to the wine (for example at an effective concentration). The wine can be allowed to age for the desired period of time. In particular examples sulfur dioxide is not added to the wine.

The present disclosure also provides compositions. In one example, the composition includes wine with tannins, lysozyme, and one or more a tannin-binding agents bound to at least a portion of the tannins in the wine. In a particular example, the composition includes at least 50 parts per million (ppm) (mg/L) lysozyme and at least 50 ppm of a tannin-binding agent (such as at least 50 or at least 600 mg/L pectin) in the composition.

### BRIEF DESCRIPTION OF THE DRAWINGS

FIGS. 1 and 2 are graphs showing absorbance of monomeric anthocyanin with varying concentrations of (1) human or (2) egg lysozyme.

FIGS. 3 and 4 are graphs showing absorbance of pinot noir wine with varying concentrations of (3) human or (4) egg lysozyme.

FIGS. 5-8 are bar graphs comparing the decrease in absorbance at (5) 280 nm (6) 420 nm, (7) 520 nm (8) and 620 nm for human and egg lysozyme in the presence of pinot noir wine.

FIG. 9 are traces showing absorbance at 520 nm 400 seconds at 25° C. when pigmented polymeric tannin (500 ppm) was mixed with varying concentrations of hen egg white lysozyme (80-4000 ppm).

### DETAILED DESCRIPTION

### Abbreviations and Terms

The following explanations of terms and methods are provided to better describe the present disclosure and to guide those of ordinary skill in the art in the practice of the present disclosure. As used herein, “comprising” means “including” and the singular forms “a” or “an” or “the” include plural references unless the context clearly dictates otherwise. For example, reference to “comprising a polysaccharide” includes one or a plurality of such polysaccharides, and reference to “comprising the tannin” includes reference to one or more tannins and equivalents thereof known to those skilled in the art, and so forth. The term “or” refers to a single element of stated alternative elements or a combination of two or more elements, unless the context clearly indicates otherwise. For example, the phrase “a polysaccharide or a protein” refers to one or more polysaccharides, one or more proteins, or a combination of one or more polysaccharides and one or more proteins.

Unless explained otherwise, all technical and scientific terms used herein have the same meaning as commonly understood to one of ordinary skill in the art to which this disclosure belongs. Although methods and materials similar or equivalent to those described herein can be used in the practice or testing of the present disclosure, suitable methods and materials are described below. The materials, methods, and examples are illustrative only and not intended to be limiting. Other features and advantages of the disclosure are apparent from the following detailed description and the claims.

L: liter

mg: milligram

nm: nanometer

ppm: parts per million

Decrease: To reduce the quality, amount, or strength of something.

In one example, an agent decreases an interaction between a polymeric tannin (such as a pigmented or non-pigmented polymeric tannin) and lysozyme (such as the formation of complexes between a pigmented polymeric tannin and lysozyme). In a particular example, a tannin-binding agent decreases an interaction between a polymeric tannin and lysozyme by a certain amount, such as a decrease of at least 10%, at least 20%, at least 50%, or even at least 90%, for example as compared to an amount of interaction in the absence of the agent. Such decreases can be measured using the methods disclosed herein.

Disaccharide: A sugar of two covalently bonded monosaccharides.

Effective amount: An amount of an agent, that alone, or together with one or more additional agents, induces the desired response.

For example, an effective amount of one or more tannin-binding agents (such as a polysaccharide) is an amount sufficient to decrease the interaction between lysozyme and a polymeric tannin to a statistically significant degree, such as by at least 25%, at least 50%, at least 75%, or at least 80%, for example as compared to the absence of the tannin-binding agent. Effective amounts of a tannin-binding agent can be determined in many different ways, such as assaying lysozyme activity or absorbance at 520 nm, for example using the methods described in Example 4. However, one skilled in the art will appreciate that other assays can be used.

For example, an effective amount of lysozyme is an amount sufficient to reduce microbial growth or the number of microbes, such as bacterial growth, to a statistically significant degree, such as by at least 25%, at least 50%, or at least 90%, for example as compared to the absence of lysozyme. Effective amounts of lysozyme can be determined in many different ways, such as assaying for the presence of microbes or for lysozyme activity, for example using the methods described in Example 4. However, one skilled in the art will appreciate that other assays can be used.

Effective concentration: The amount of an agent needed to produce a desired effect, such as an amount of lysozyme needed to substantially kill or inhibit growth of bacteria (such as those present in a solution), or the amount of a tannin-binding agent needed to substantially reduce the interaction between lysozyme and polymeric tannins.

Fermentation: Process in which an agent causes an organic substance to break down into simpler substances, such as the anaerobic breakdown of sugar into alcohol and carbon dioxide by yeast. Fermentation can be used to convert grape juice into wine.

Guar gum (guaran; E412): A water soluble polysaccharide, consisting of mannose and galactose units. Guar gum is usually extracted from the seed of the leguminous shrub Cyamopsis tetragonoloba.

Gum arabic (arabic gum, acacia, acacia gum, acacia syrup, Indian gum): The dried gum of the Acacia senegal, which includes high molecular weight polysaccharides and can be used to produce arabinose, galactose, rhamnose and glucuronic acid. Gum arabic is commonly used in food as a thickener, stabilizer, glazing agent and emulsifier, and is readily water-soluble.

Increase or enhance: To improve the quality, amount, or strength of something.

In one example, an agent enhances or increases the effective concentration of lysozyme, if the same amount of lysozyme is more effective at reducing the presence of microbes, as compared to the absence of the agent.

In a particular example, a tannin-binding agent enhances or increases the effective concentration of lysozyme in the presence of polymeric tannin, if the lysozyme antimicrobial activity increases in the presence of the tannin-binding agent, such as an increase of at least 10%, at least 20%, at least 50%, or even at least 90%, for example as compared to an amount of lysozyme antimicrobial activity in the absence of the agent. Such enhancement can be measured using the methods disclosed herein.

Introduce: To cause an agent to be added to an environment, for example to add one or more agents into a fermented product such as wine.

Lysozyme: A family of enzymes (EC 3.2.1.17) that catalyze the hydrolysis of certain mucopolysaccharides of bacterial cell walls, specifically the β(1-4) glycosidic linkages between N-acetylmuramic acid and N-acetylglucosamine, and cause bacterial lysis. Lysozymes that can be used herein include, but are not limited to, naturally-occurring lysozymes, synthetic lysozymes, and recombinant lysozymes. One particular example is hen egg lysozyme.

Microbe or microbial: Microscopic organisms capable of causing disease (for example in a human or other mammal) or capable of causing spoilage or other undesirable degradation or alteration of foods or beverages (such as wine). Particular examples include but are not limited to, fungi, viruses, and bacteria. The term “anti-microbial” will thus be used herein to refer to an agent (or combination of agents) that retard or decrease the growth of one or more microbes, and in some examples inhibit the growth of or even kill one or more microbes. In a specific example, an anti-microbial agent can reduce the growth of or kill at least 99% of present in a liquid composition, such as wine.

Monosaccharide: A simple sugar, such as pentose and hexose sugars.

Must: Grapes (such as grape juice, skins and pulp) used to make wine, for example the juice from grapes before and during fermentation.

Pectin: Pectin (E440) is a heterogeneous grouping of acidic structural polysaccharides found in the cell wall of plants. Pectins are very variable in composition; chain lengths are variable and there is a high complexity in the combination and order of each of the monosaccharide derivative units. Generally, pectin is composed of three main polysaccharide types; polygalacturonan (composed of repeated galacturonic acid monosaccharide subunits), rhamnogalacturonan I (composed of alternating rhamnose and galacturonic acid subunits) and rhamnogalacturonan II (a complex, highly branched polysaccharide).

In particular examples, the majority of pectin consists of homopolymeric partially methylated poly-a-(1→4)-D-galacturonic acid residues with substantial ‘hairy’ non-gelling areas of alternating α-(1→2)-L-rhamnosyl-α-(1→4)-D-galacturonosyl sections containing branch-points with mostly neutral side chains (1-20 residues) of mainly L-arabinose and D-galactose (rhamnogalacturonan I). Pectins can also include rhamnogalacturonan II sidechains containing other residues such as D-xylose, L-fucose, D-glucuronic acid, D-apiose, 3-deoxy-D-manno-2-octulosonic acid (Kdo) and 3-deoxy-D-lyxo-2-heptulosonic acid (Dha) attached to poly-a-(1→4)-D-galacturonic acid regions.

Pectin preparations include substructural entities that depend on their source and extraction methodology. For example, commercial extraction can cause extensive degradation of the neutral sugar-containing sidechains. Sources of pectin include fruit and vegetables, such as citrus peel and apple pomace.

Polysaccharide: Polymers of monosacchardies and disaccharides joined together by glycosidic linkages, such as a polymer of glucose. When all the constituent monosaccharides are of the same type they are termed homopolysaccharides; when more than one type of monosaccharide is present they are termed heteropolysaccharides. In particular examples, they are large, often branched, molecules. Particular examples of polysaccharides include, but are not limited to: starch, chitin, cellulose, pectin, guar gum, gum arabic, and glycogen.

Classes of polysaccharides include polymonosaccharides (such as arabinan, xylan, glucan [for example amylose, callose, cellulose, dextran], nigeran, mannan, galactan, pectic acid, and chitin), polydisaccharides (such as agarose, alginate, and carrageenan), polytrisaccharides, polytetrasaccharides (such as gellan), polypentasaccharides (such as xanthan), and complex polysaccharides (such as gum Arabic, pectin [for example citrus pectin, amidated pectin, high methoxy pectin, low methoxy pectin, apple pectin, sugar beet pectin, potato pectin, and RGII pectin] and starch).

ppm (parts per million): A unit used to express the concentration of an agent in a composition as measured by the number of milligrams per volume of liquid (mg/L). Therefore, 1 ppm is equivalent to 1 mg of any substance dissolved (or suspended) in 1 L of liquid (1 mg/L). For example 600 ppm pectin is equivalent to 600 mg pectin per liter of liquid (such as wine).

Tannin (or tannic acid): Tannins are naturally occurring plant polyphenols, which are usually divided into hydrolyzable tannins and condensed tannins (proanthocyanidins). A monomeric tannin is a single tannin molecule, while a polymeric tannin is one that includes two or more covalently bonded monomeric tannins. Generally, younger wines contain greater amounts of monomeric tannins than older wines. Tannins generally have molecular weights ranging from 500 to over 20,000. These astringent complex phenolic substances impart an astringent or bitter taste, for example in red wine.

At the center of a hydrolyzable tannin molecule, there is a polyol carbohydrate (usually D-glucose). The hydroxyl groups of the carbohydrate are partially or totally esterified with phenolic groups such as gallic acid (in gallotannins) or ellagic acid (in ellagitannins). Hydrolyzable tannins are hydrolyzed by weak acids or weak bases to produce carbohydrate and phenolic acids. Some define two additional classes of hydrolyzable tannins: taragallotannins (gallic acid and quinic acid as the core) and caffetannins (caffeic acid and quinic acid).

Condensed tannins, also known as proanthocyanidins, are polymers of 2 to 50 (or more) flavonoid units that are joined by carbon-carbon bonds, which are not susceptible to being cleaved by hydrolysis. While hydrolyzable tannins and most condensed tannins are water soluble, some very large condensed tannins are insoluble.

Tannin is a naturally occurring substance in grapeskins, seeds and stems. Generally, since white wines are produced from the uncoloured juice of red or white grapes, and usually without skin contact, and red wines are produced from red grapes using a period of fermentation on the skins, white wines are consequently much lighter in tannin than reds.

Tannin-binding or complexing agent: An agent that can bind to tannin (such as polymeric tannin), for example via the hydroxyl or carboxyl groups of tannins. In one example, a tannin-binding agent masks one or more binding sites present on a tannin, such as masking of a negative charge. Ideally, such an agent does not significantly adversely affect the tannin, for example does not significantly result in precipitation of the tannin. Particular examples include, but are not limited to, carbohydrates, proteins, polysaccharides, such as agar, gelatin, and pectin.

Under conditions sufficient for: A phrase that is used to describe any environment that permits the desired activity.

In one example, includes incubating wine with a tannin-binding agent to allow the desired activity. In particular examples the desired activity is the binding of the tannin-binding agent to a tannin in the wine, for example the formation of a complex between the tannin-binding agent and the tannin. In other particular examples, the desired activity includes increasing the effective concentration of lysozyme in the wine, due to the binding of the tannin-binding agent to tannin.

Wine: Includes every kind (class and type) of product produced from fermentation of grapes, other fruit (including berries), or other suitable agricultural products and containing at least 0.5% alcohol by volume, but not more than 24% of alcohol by volume, for example 8%-24% alcohol by volume, such as 10-24% alcohol by volume, such as 10-15% alcohol by volume. The term includes all imitation or artificial wine and compounds sold as wine. Wine can have at least 0.6% alcohol by volume, such as at least 1% alcohol by volume, at least 5% alcohol by volume, at least 8% alcohol by volume, at least 10% alcohol by volume, at least 12% alcohol by volume, or at least 14% alcohol by volume.

### Methods of Reducing Interactions Between Wine Tannins and Lysozyme

Disclosed herein are methods that decrease the interaction between lysozyme and wine components, such as tannins. The interaction between lysozyme and wine components is any interaction that results in decreased availably of lysozyme for antimicrobial activity, thereby decreasing the effective concentration of lysozyme in the wine. Examples of binding include ionic interactions, complex formation, binding, and so forth. In particular examples, such a method increases the antimicrobial effectiveness of lysozyme, for example by decreasing the amount of lysozyme that precipitates out of solution when interacting with polymeric tannins, thereby increasing the amount of lysozyme in solution available for antimicrobial activity. Methods of determining antimicrobial activity are known in the art, and can include (but are not limited to) a lysozyme activity assay (see Example 4) and bacterial growth assays (for example growing bacteria in a liquid culture containing wine, lysozyme, and the presence or absence of the tannin-binding agent, and comparing the growth of bacteria, for example by counting bacterial colonies on a plate streaked with the liquid culture).

Tannins are polyphenols, which have the ability to interact with other agents. In one example, the tannin-binding agent interacts with polymeric tannins, such as pigmented polymeric tannins.

In particular examples, the method of decreasing an interaction between tannin and lysozyme includes introducing one or more tannin-binding agents to wine that includes tannin, under conditions sufficient to permit the tannin-binding agent to interact with at least a portion of tannin in the wine. The resulting interaction between the tannin-binding agent and tannin, such as masking negative charges on the tannin or the formation of a complex, can decrease interactions between wine tannin and lysozyme, for example decrease the formation of a lysozyme/tannin precipitate in the wine. The method can also include introducing lysozyme into the wine, such as an amount effective at reducing bacterial growth by at least 90%, such as at least 95%, or at least 99%.

The interaction between the tannin-binding agent and wine tannin can be any interaction that results in decreased binding between tannin and lysozyme. Ideally, such as interaction does not significantly interfere with the activities of the tannin. For example, the interaction between the tannin-binding agent and wine tannin can alter the sites on tannin that interact with lysozyme, such that the interaction between lysozyme and tannin is decreased. In a specific example, the interaction between the tannin-binding agent and wine tannin is ionic or electrostatic. For example, the tannin-binding agent can mask negative charges present on the tannin, thereby decreasing the interaction with positively charged molecules such as lysozyme. In another specific example, the interaction between the tannin-binding agent and wine tannin is the formation of a stable, but not precipitated, complex.

In particular examples, tannin-binding agents are added into wine at an effective concentration, such as a concentration sufficient to at least partially reduce the interaction between tannins in the wine and lysozyme. The resulting decrease is any decrease that reduces or eliminates the formation of lysozyme/tannin precipitate in the wine, thereby increasing the effective concentration of lysozyme in the wine. In a particular example, the interaction between the tannin and the lysozyme is decreased by at least 25% as compared to interaction in the absence of the tannin-binding agent, such as a decrease of at least 50%, at least 70%, at least 80%, or at least 90%.

In particular examples, decreasing the interaction between tannin and lysozyme in the wine increases the amount of lysozyme antimicrobial activity, for example by increasing the effective concentration of the lysozyme in the wine. The observed increase can be relative to a control or reference standard, such as an amount of lysozyme antimicrobial activity (or effective concentration) in absence of the tannin-binding agent. For example, if 200 ppm of lysozyme is needed to have the desired antimicrobial activity (such as killing or reducing the growth of one or more types of microbes) in the absence of the tannin-binding agent, a lower amount of lysozyme is needed to achieve the same amount of antimicrobial activity in the presence of one or more tannin-binding agents, such as an amount no more than 200 ppm lysozyme (such as 40-200 ppm lysozyme, 40-100 ppm lysozyme, 40-600 ppm lysozyme, or 60-200 ppm lysozyme). In one example, the effective concentration of lysozyme increases by at least 25%, such as at least 50%, at least 75%, or at least 90% in the presence of one or more tannin-binding agents, for example as compared to the effective concentration of lysozyme in the wine in the absence of the tannin-binding agent(s).

In one example, the decreased interaction between tannin and the lysozyme is determined by measuring absorbance at 520 nm, wherein a decrease in absorbance at 520 nm indicates the formation of lysozyme/tannin precipitate. Therefore, an increase in absorbance at 520 nm in the presence of the tannin-binding agent, such as an increase of at least 50%, indicates that the interaction between tannin and the lysozyme is reduced. In another example, the decreased interaction between tannin and the lysozyme is determined by measuring lysozyme activity. For example, lysozyme activity can be determined by measuring substrate disappearance (such as a cell wall substrate), wherein a decrease in the turbidity at 450 nm of an insoluble substrate indicates the presence of lysozyme activity. Therefore, a decrease in absorbance at 450 nm (for example at 25° C.) in the presence of the tannin-binding agent (for example as compared to absence of the tannin-binding agent), such as an increase of at least 25% (such as at least 50%, at least 75%, or at least 90%) indicates that the interaction between tannin and the lysozyme is reduced.

The tannin-binding agent can be introduced to the wine at any appropriate time during winemaking. In particular examples one or more tannin-binding agents (such as 1, 2, 3, 4, 5, or more different tannin-binding agents) are added after fermentation, for example before clarifying or aging the wine.

In some examples, the tannin-binding agent and the lysozyme are added to the wine at the same time. In other examples, the tannin-binding agent is added prior to adding the lysozyme. For example, the lysozyme can be added after the tannin-binding agent has sufficiently interacted with tannins present in the wine, such as after the tannin-binding agent has sufficiently neutralized negative charges on the tannins. In a particular example, lysozyme is added to the wine at least 5 minutes after introducing the tannin-binding agent, such as at least 10 minutes, at least 30 minutes or at least 60 minutes after adding the tannin-binding agent (for example 5-120 minutes, 5-60 minutes, or 10-60 minutes.

### Tannin-Binding Agents

Tannin-binding agents are molecules that can interact with tannin, thereby decreasing the interaction between tannin and lysozyme. The interaction between tannin-binding agents and tannin can be any interaction that reduces the interaction between tannin and lysozyme. Examples of particular types of interactions include, but are not limited to: complex formation between the tannin-binding agent and tannin, hydrophobic and hydrogen bonding, and ionic or electrostatic interactions. Tannin-binding agents are therefore molecules that can be added to wine to reduce the interaction between tannin and lysozyme, thereby increasing the amount of lysozyme available for antimicrobial activities.

Ideally, a tannin-binding agent is non-toxic to humans at the effective dose, is generally recognized as safe, effective at low concentrations, easy to add during the winemaking process, economically feasible to use, or combinations thereof. Examples of tannin-binding agents include but are not limited to, polysaccharides, proteins, carbohydrates, or combinations thereof. However, one skilled in the art will appreciate that other tannin-binding agents can be used to practice the methods and compositions disclosed herein.

In one example, a carbohydrate tannin-binding agent has a high molecular weight, low solubility, and conformational flexibility. Particular examples of carbohydrate tannin-binding agents include, but are not limited to, starch and cellulose.

In one example, a protein tannin-binding agent has a large molecular size, open and flexible structures, richness in proline, or combinations thereof. In one example, the interaction between the protein tannin-binding agent and tannin is hydrogen bonding between the tannin's phenolic group and the protein's carboxyl group. Particular examples of protein tannin-binding or complexing agents are gelatin, albumin and casein.

Particular examples of polysaccharide tannin-binding agents include pectin, starch, chitin, cellulose, guar gum, gum arabic, glycogen, or combinations thereof. In a specific example, the polysaccharide tannin-binding agents include pectin, guar gum, gum Arabic, or combinations thereof. In one specific example, the tannin-binding agent is pectin.

In particular examples, tannin-binding agents are added to wine at an effective amount. An effective amount of a tannin-binding agent is an amount sufficient to decrease the interaction between tannin and lysozyme. In one example, an effective amount of a tannin-binding agent substantially reduces the interaction between tannin and lysozyme, such as by at least 30%, at least 50%, at least 70%, at least 75%, or at least 80%. However, the maximum amount of tannin-binding agent should not be so great as to significantly negatively alter the desirable sensory attributes of tannin (such as color, smell, and taste), and not be so great as to significantly decrease the antimicrobial activity of lysozyme. Effective amounts of a tannin-binding agent may vary depending on the source of the tannin-binding agent.

Specific examples of effective amounts of a tannin-binding agent include, but are not limited to, at least 50 parts per million (ppm) of a tannin-binding agent in the wine (also represented as 50 mg tannin-binding agent/L wine), such as at least 100 ppm (100 mg/L), at least 250 ppm (250 mg/L), at least 600 ppm (600 mg/L), at least 1000 ppm (1000 mg/L), or even at least 1500 ppm (1500 mg/L), such as 50 ppm to 1500 ppm, 50 ppm to 1000 ppm, 100 ppm to 500 ppm, or 150-600 ppm tannin-binding agent. In a particular example, the effective amount of a tannin-binding agent is at least 600 ppm pectin, such as 600-1500 ppm pectin, 600-1000 ppm pectin, 750-1000 pectin, or 600-800 ppm pectin.

### Lysozyme

Lysozymes (also known as muramidase or N-acetylmuramyl hydrolase) are natural antimicrobial polypeptides that occur in diverse organisms including viruses, birds, mammals, and plants. Lysozyme is therefore an antimicrobial agent that can be added to wine to reduce the growth of microbes, or even kill microbes present in wine. Lysozymes that can be used herein include, but are not limited to, naturally-occurring lysozymes, synthetic lysozymes, and recombinant lysozymes. In humans, lysozymes are found in spleen, lung, kidney, white blood cells, plasma, saliva, milk, tears, and cartilage. Thus, lysozyme can be isolated from milk, tear fluid, saliva and nasal mucus of humans. The human form can also be produced recombinantly. Lysozyme is found in the milk and the colostrum of cows. Lysozyme can also be obtained from cauliflower juice. However, the most common source which allows lysozyme to be extracted on an industrial scale is chicken albumen.

In particular examples, lysozyme is added into wine at an effective amount. An effective amount of lysozyme is an amount sufficient to provide antimicrobial activity. In one example, an effective amount of lysozyme substantially reduces the number of microbes present in wine (such as bacteria), such as by at least 90%, at least 95%, at least 99% or even 100%. However, the maximum amount of lysozyme should not be so great as to significantly negatively alter the desirable properties of wine, such as color and taste. Effective amounts of lysozyme may vary depending on the source of the lysozyme. Some are more potent than others; for example chicken lysozyme is less active than human lysozyme. In particular examples, an effective amount of lysozyme is at least 50 parts per million (ppm) in the wine (also represented as 50 mg lysozyme/L wine), such as at least 100 ppm (100 mg/L), at least 200 ppm (200 mg/L), at least 300 ppm (300 mg/L), at least 400 ppm (400 mg/L), at least 500 ppm (500 mg/L), at least 1000 ppm (1000 mg/L) or even at least 1400 ppm (1400 mg/L), such as 50 ppm to 500 ppm, or 50 ppm to 100 ppm.

### Methods of Making Wine

The present disclosure also provides methods for producing wine. In particular examples, the methods include introducing a tannin-binding agent into wine such as following fermentation under conditions sufficient to permit the tannin-binding agent to interact with at least a portion of the tannins present in the fermented wine product, and subsequently introducing lysozyme. The resulting interaction between the tannin-binding agent and the tannins decreases the interaction between tannins and the lysozyme.

For example, the method can include producing a must and then fermenting the must to produce a wine that includes tannins, such as polymeric tannins. One or more tannin-binding agents are added to the wine (for example in an effective amount) under conditions sufficient to permit the tannin-binding agent to bind to the tannins. A particular example of a tannin-binding agent is pectin. Subsequently, lysozyme is added to the wine (for example in an effective amount). The wine is then allowed to age. In particular examples, sulfur dioxide may or may not added to the wine. In a specific example, sulfur dioxide is not added to the wine.

### Compositions

Also provided by the present disclosure are compositions that include wine, lysozyme, and a tannin-binding agent bound to at least a portion of tannins. In some examples, the wine is at least 5% alcohol by volume, such as at least 10% alcohol by volume. In some examples the tannin-binding agent increases the effective concentration of lysozyme by at least 50%, for example as compared to the effective concentration of lysozyme in the absence of the tannin-binding agent.

In a particular example, the composition includes lysozyme at a concentration of at least 50 ppm in the composition, such as at least 100 ppm, or at least 500 ppm, such as 50 ppm to 4000 ppm, 50 ppm to 1000 ppm, 50 ppm to 100 ppm, or 100 ppm to 500 ppm in the composition. Alternatively or in addition, the composition can include one or more tannin-binding agents (such as one or more polysaccharides, proteins, carbohydrates, or combinations thereof) at a concentration of at least 600 ppm in the composition, such as at least 800 ppm, at least 1000 ppm, for example, 600 ppm to 1500 ppm in the composition. In a specific example, the composition includes least 600 ppm pectin, such as 600-1500 ppm pectin, 600-2000 ppm pectin, or 1000-1500 ppm pectin.

In a particular example, the one or more tannin-binding agents include a polysaccharide, such as pectin, starch, chitin, cellulose, guar gum, gum arabic, glycogen, or combinations thereof. In a more specific example, the one or more tannin-binding agents include pectin, guar gum, gum Arabic, or combinations thereof.

Particular non-limiting examples of compositions are disclosed. For example, the composition can include wine containing polymeric tannins, at least 50 ppm lysosome and at least 50 ppm pectin, such as 50 ppm to 500 ppm lysosome and 50 ppm to 1500 ppm pectin.

### Example 1

### Lysozyme is not Significantly Reactive with Monomeric Tannin

This example describes methods used to demonstrate that monomeric anthocyanins present in wine do not significantly bind to lysozyme.

A purified preparation (>90%) of monomeric anthocyanin isolated from Pinot noir wine using known methods (Kennedy and Taylor, J. Chromatogr. A. 995:99-107, 2003, herein incorporated by reference). The isolated monomeric anthocyanin was solubilized in a 5% tartaric acid solution to a concentration of 500 mg/L. The pH was adjusted to 3.5 with NaOH. Lysozyme (human or egg; Fordras Sa. Lugano, Switzerland) stock solution (10% w/v) was added to give final concentrations of 50 ppm, 150 ppm, 300 ppm and 500 ppm. Mixtures were held at room temperature for 24 hours and absorbance read in a 1 mm pathlength cuvette at 280 nm, 420 nm, 520 nm, and 620 nm. Samples to be read at 280 nm were diluted 100 fold. Absorbance at 280 nm provides an estimate of total phenols and proteins; absorbance at 420 nm provides an estimate of the concentration of yellow/brown pigments; absorbance at 520 nm provides an estimate of red colored anthocyanins; and absorbance at 620 nm provides an estimate of the quinodal form (blue colored) of anthocyanins.

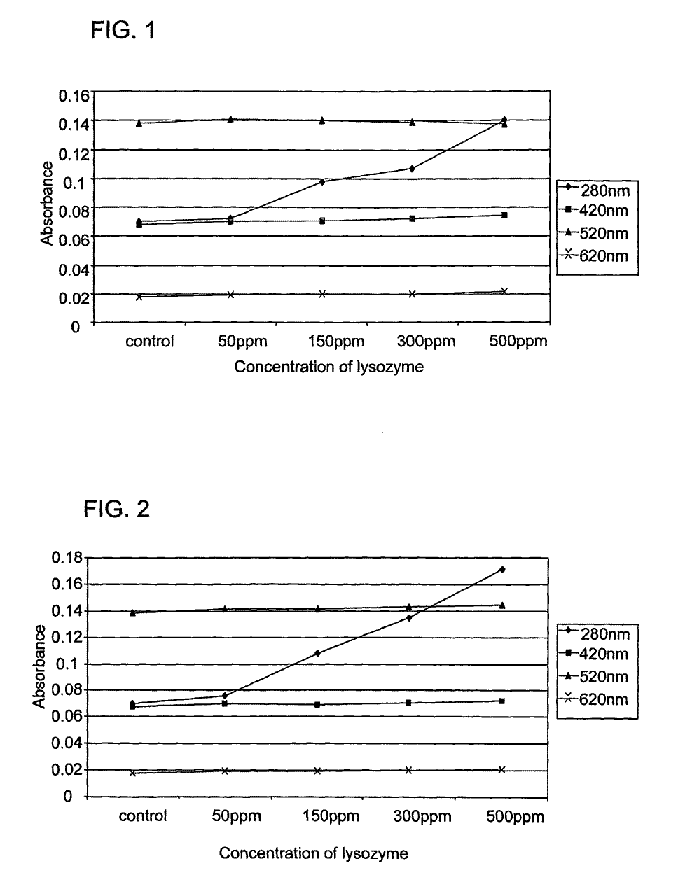

As shown in FIGS. 1 and 2, the addition of human (FIG. 1) or egg (FIG. 2) lysozyme to monomeric anthocyanin did not elicit any significant change in absorbance at either 420 nm, 520 ™ or 620 nm. The increases at 280 nm were due to the increased lysozyme concentration. Proteins such as lysozyme will absorb in the UV spectrum. No sediment or precipitation was observed in any of the treatments.

Therefore, lysozyme is not significantly reactive toward monomeric anthocyanin, as no color loss (absorbance) and no visible precipitation were observed.

### Example 2

### Lysozyme is Reactive with Components Present in Pinot Noir

This example describes methods used to demonstrate that although monomeric anthocyanin was not significantly reactive with lysozyme, there are wine components that do interact with lysozyme.

To a 2003 Willamette Valley Pinot noir wine, different concentrations (0, 50, 150, 300, or 500 ppm) of egg or human lysozyme were added. Wines were held for 24 hours and read in a spectrophotometer in a 1 mm pathlength cuvette at 280, 420, 520, and 620 nm. Samples to be read at 280 nm were diluted 100 fold. All wine with added lysozyme formed precipitates which increased proportionally with the amount of lysozyme added.

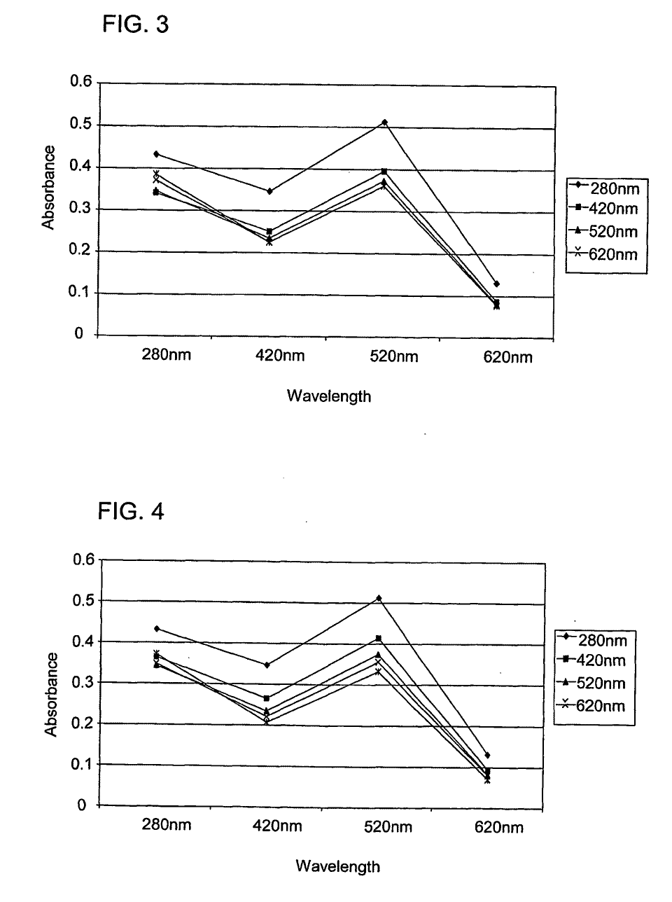

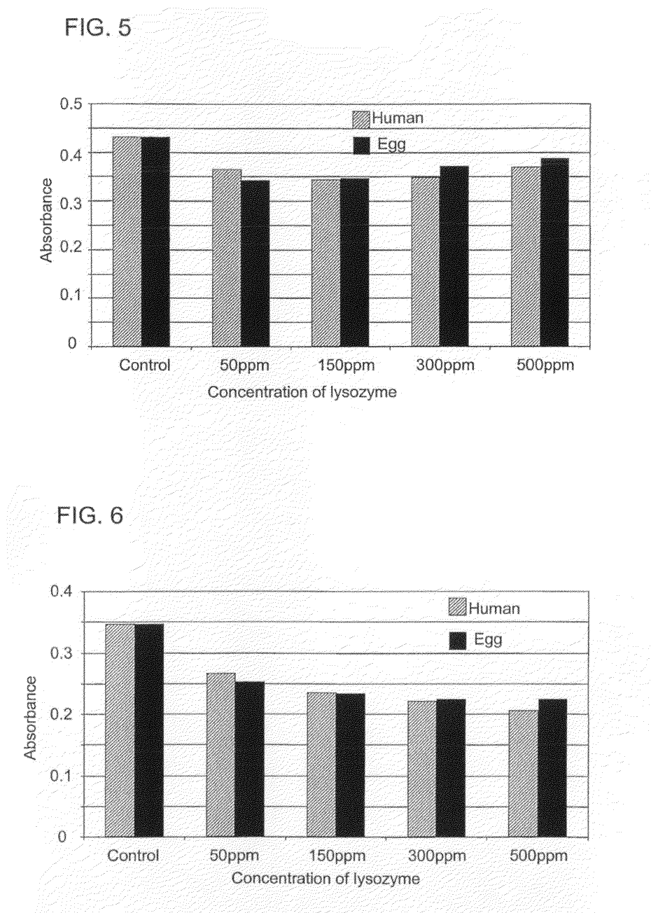

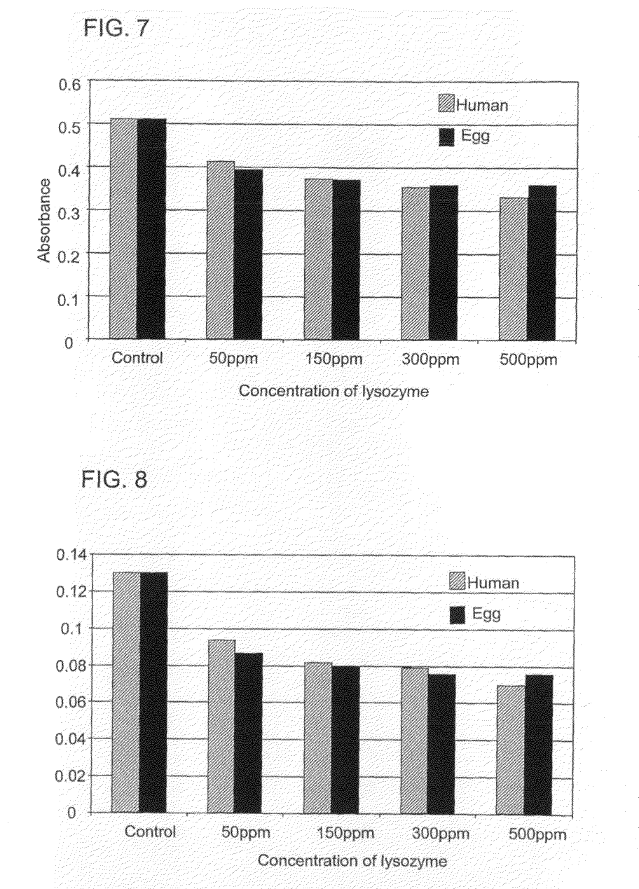

As shown in FIGS. 3 and 4, egg and human lysozyme decrease the absorbance at all wavelengths indicating an interaction of lysozyme with pigments and phenolics. The largest decrease in absorbance occurred when lysozyme concentration was increased from 0 to 50 ppm. Further increases in lysozyme concentration (150-500 ppm) did not significantly further decrease absorbance. After an initial decrease in absorbance, slight increases at 280 nm occurred upon addition of more lysozyme indicating protein absorbance. FIGS. 5-8 provide a direct comparison of egg and human lysozyme at each wavelength, and the results indicate no significant differences between egg and human lysozyme in decreasing absorbance at each wavelength.

In summary, lysozyme interacted and precipitated wine components resulting in decreased absorbance at several wavelengths.

### Example 3

### Pigmented Polymeric Tannins Interact with Lysozyme

This example describes methods used to demonstrate that polymeric tannins in wine react with lysozyme.

Pigmented polymeric tannin was obtained from 3-year-old Pinot noir wine using known methods (Hayasaka and Kennedy, Australian J. Grape Wine Research 9:210-20, 2003, herein incorporated by reference). Briefly, wine was concentrated under reduced pressure at 35° C. and the polymeric materials isolated using Toyopearl TSK HW 40-F size exclusion media (Supelco, St. Louis, Mo.).

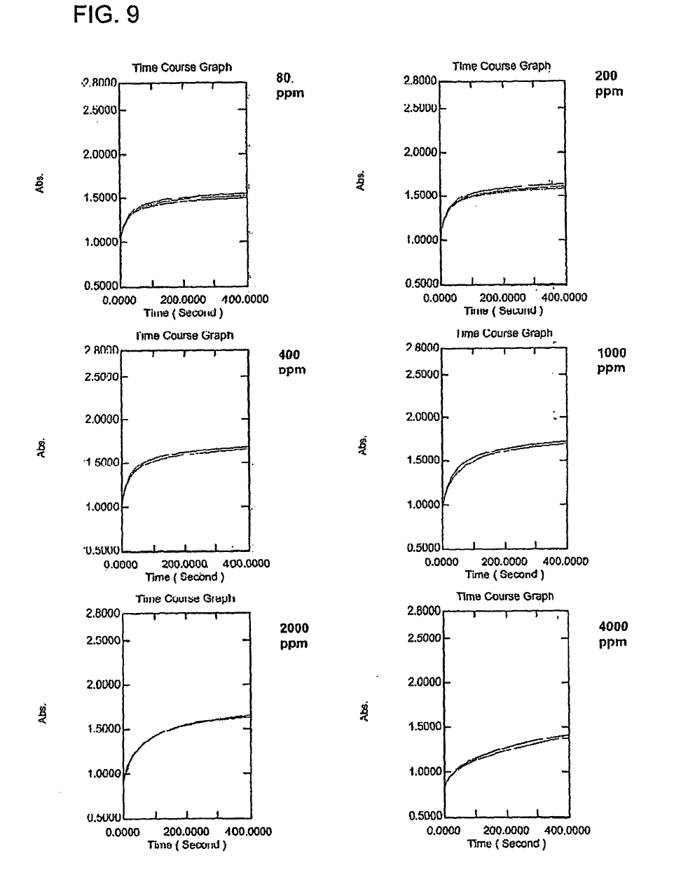

Addition of hen egg white lysozyme (80-4000 ppm) to pigmented polymeric tannin (500 ppm) in pH 3.5, 0.5% tartaric acid solution resulted in immediate formation of a colloidal haze with particles in excess of 25 μm as seen with dark field microscopy. Rates of haze formation were determined by monitoring absorbance (420, 520, 620 nm) at 15, 20, 25 or 30° C. over time. Maximum haze formation was >90% complete within 30 minutes for all variables. A typical example is shown in FIG. 9.

Samples of the above polymeric pigmented tannin/lysozyme reactions were centrifuged to remove haze complexes and remaining color measured by absorbance at 520 nm.

As shown in Table 1, color loss increases with increasing lysozyme concentration. However, the percent color loss reaches a maximum at approximately a concentration of 4 parts lysozyme to 1 part tannin.

TABLE 1
Absorbance (520 nm) of pigmented polymeric tannin exposed to lysozyme

| | Lysozyme Concentration (ppm) | | | | | | | | |
|---|---|---|---|---|---|---|---|---|---|
| | 0 | 20 | 40 | 100 | 200 | 400 | 1000 | 2000 | 4000 |
| Sample 1 | 0.432 | 0.370 | 0.310 | 0.236 | 0.210 | 0.198 | 0.185 | 0.184 | 0.202 |
| Sample 2 | 0.432 | 0.362 | 0.307 | 0.239 | 0.213 | 0.201 | 0.190 | 0.185 | 0.198 |
| Sample 3 | 0.432 | 0.370 | 0.308 | 0.242 | 0.220 | 0.200 | 0.192 | 0.185 | 0.194 |
| Average | 0.432 | 0.367 | 0.308 | 0.239 | 0.214 | 0.200 | 0.189 | 0.185 | 0.198 |
| % of original | 100 | 85.03 | 71.37 | 55.32 | 49.39 | 46.01 | 43.55 | 42.55 | 45.62 |
| absorbance | | | | | | | | | |

As shown in Table 2, the addition of 15% ethanol (v/v), to mimic that found in wine, reduced the amount of measurable color; however the effect was not as pronounced in the presence of ethanol.

TABLE 2
Absorbance (520 nm) of pigmented polymeric tannin exposed to lysozyme in 15% v/v
ethanol

| | Lysozyme Concentration (ppm) | | | | | | | | |
|---|---|---|---|---|---|---|---|---|---|
| | 0 | 20 | 40 | 100 | 200 | 400 | 1000 | 2000 | 4000 |
| Sample 1 | 0.645 | 0.621 | 0.612 | 0.580 | 0.572 | 0.554 | 0.534 | 0.494 | 0.477 |
| Sample 2 | 0.645 | 0.619 | 0.612 | 0.595 | 0.578 | 0.570 | 0.518 | 0.503 | 0.484 |
| Sample 3 | 0.645 | 0.618 | 0.615 | 0.585 | 0.575 | 0.576 | 0.530 | 0.503 | 0.489 |
| Average | 0.645 | 0.619 | 0.613 | 0.587 | 0.575 | 0.567 | 0.527 | 0.500 | 0.483 |
| % of original | 100 | 96.47 | 95.48 | 91.38 | 89.15 | 87.86 | 81.76 | 77.52 | 74.94 |
| absorbance | | | | | | | | | |

In summary, monomeric tannin is essentially non-reactive to lysozyme. However, in wine and in solutions of pigmented polymeric tannin, lysozyme causes a haze to form and reduces the amount of color pigment. Wine contains varying mixtures of monomeric and polymeric pigments with the latter predominating as wine ages. Lysozyme carries a strong positive charge at wine pH (3.5) due its isoelectric point of 10.5. Without wishing to be bound to a particular theory, lysozyme may react with polymeric tannin by hydrogen binding between its peptide bonds and the tannin phenolic hydroxyls resulting in precipitation.

### Example 4

### Polysaccharides Decrease Polymeric Tannin-Lysozyme Interactions

This example describes methods used to demonstrate that addition of the polysaccharide pectin to wine prior to adding lysozyme, protects pigmented polymeric tannin from binding to lysozyme, thereby reducing color loss and haze formation, and reversing the decrease of lysozyme biological activity.

Pectin (600 ppm or 1500 ppm; U.S.P. Citrus pectin, Spectrum Chemical Corp., New Brunswick, N.J.) was added to pigmented polymeric tannin (500 ppm) obtained from pinot noir (see Example 3) in pH 3.5, 0.5% tartaric acid and allowed to stand for 30 minutes at room temperature. Lysozyme was added at 40-2000 ppm. The sample was held for 400 seconds and then centrifuged. A sample of the supernatant was removed and assayed for color absorbance at 520 nm and for lysozyme activity.

Lysozyme activity was determined as follows. The assay indirectly determines the concentration of lysozyme in a sample by measuring enzymatic activity under defined conditions, and then relating activity to ppm (mg/L) lysozyme from a standard curve. Lysozyme activity was determined by measuring the rate of substrate disappearance, wherein a decrease in the turbidity of an insoluble substrate is an indicator of lysozyme activity. Typically, wine samples were substantially diluted (20-100 fold) to reach an optimal concentration of enzyme to react with substrate. Dilution also dilutes wine components to the point where their influence on enzymatic activity is negligible.

A lysozyme standard curve was established using 2 ppm (mg/L) to 8 ppm (mg/L) lysozyme (Fordras, S. a) in deionized distilled water. The cell wall substrate (Micrococcus lysodekticus cell wall substrate, M-3770, Sigma, St. Louis, Mo.) was dissolved in 0.15 M phosphate buffer, pH 6.2 to obtain an absorbance between 0.60 and 0.80 at 450 nm. The substrate was equilibrated at 25° C. The substrate was periodically agitated to maintain an evenly distributed suspension.

The standard lysozyme solution (100 μl) followed by 2.50 mL of substrate was added to a cuvette and the change in absorbance at 450 nm at 25° C. measured on a spectrophotometer. The absolute value of the change in absorbance per minute from the values obtained between 20 and 40 seconds after the initiation of the reaction was determined. The activity is the Δ absorbance/minute multiplied by 10,000. This was repeated several times (5-10) for each standard solution until to ensure that the values did not deviate more than 20% from the mean. Typically, activities corresponding to 3 and 6 ppm lysozyme provide good linearity.

The average activities versus the known ppm lysozyme were plotted to determine over what range the relationship is linear (R²≧0.95), and the equation solved for the best fit over this linear range such that (ppm lysozyme)=m(average activity)+b. The standard curve was used to determine lysozyme activity in wine samples.

As shown in Tables 3 and 4, the addition of pectin to tannin prior to exposure to lysozyme resulted in less color loss and a greater residual lysozyme activity. Therefore, addition of pectin at least partially prevents the ability of lysozyme to react with tannin and precipitate it out.

TABLE 3
Interaction of polymeric tannin with lysozyme (40-200 ppm) +/− pectin
Lysozyme Activity Measurements

| Samples With 600 ppm Pectin | | | | |
|---|---|---|---|---|
| Lysozyme Added (ppm) | 0 | 40 | 100 | 200 |
| Residual Lysozyme (ppm) | 0 | 12.84 | 65.86 | 98.84 |
| Samples Without Pectin | | | | |
| Lysozyme Added (ppm) | 0 | 40 | 100 | 200 |
| Residual Lysozyme (ppm) | 0 | 0 | 7.93 | 33.51 |

Color Absorbance Measurements (520 nm)

| | | | | |
|---|---|---|---|---|
| Samples With 600 ppm Pectin | | | | |
| Lysozyme Added (ppm) | 0 | 40 | 100 | 200 |
| Average | 0.837 | 0.396 | 0.427 | 0.454 |
| Samples Without Pectin | | | | |
| Lysozyme Added (ppm) | 0 | 40 | 100 | 200 |
| Average | 0.626 | 0.236 | 0.209 | 0.202 |

TABLE 4
Interaction of polymeric tannin with lysozyme +/− pectin
Lysozyme Activity Measurements

| Samples With 1500 ppm Pectin | | | | |
|---|---|---|---|---|
| Lysozyme Added (ppm) | 0 | 400 | 1000 | 2000 |
| Residual Lysozyme (ppm) | 0 | 188.22 | 915.62 | 1698.79 |
| Samples Without Pectin | | | | |
| Lysozyme Added (ppm) | 0 | 400 | 1000 | 2000 |
| Residual Lysozyme (ppm) | 0 | 72.39 | 784.7 | 1590.21 |

Color Absorbance Measurements (520 nm)

| | | | | |
|---|---|---|---|---|
| Samples With 1500 ppm Pectin | | | | |
| Lysozyme Added (ppm) | 0 | 400 | 1000 | 2000 |
| Average | 0.623 | 0.538 | 0.541 | 0.571 |
| Samples Without Pectin | | | | |
| Lysozyme Added (ppm) | 0 | 400 | 1000 | 2000 |
| Average | 0.623 | 0.172 | 0.116 | 0.126 |

Without wishing to be bound to a particular theory, it is proposed that pectin modifies the surface chemistry of tannin such that lysozyme is not as reactive to tannin. For example, electrostatic and hydrogen binding interactions may effectively neutralize the attraction between tannin and lysozyme. The pectin/tannin complex appears to be stable and does result in the formation of a precipitate.

### Example 5

### Use of Tannin-Binding Agents in Wine

This example describes methods that can be used to add one or more tannin binding agents to wine, thereby increasing the availably (and thus the anti-microbial activity) of lysozyme added to the wine. Although particular methods are provided in this example, one skilled in the art will appreciate that other tannin-binding agents at different concentrations can be used.

Generally, there are five basic steps to making wine: harvesting, crushing and pressing, fermentation, clarification, and aging and bottling. Generally, one or more tannin-binding agents are added to the wine following fermentation, and prior to clarification. After adding the one or more tannin-binding agents to the wine after fermentation, the tannin binding agents are incubated with the wine for a time sufficient for the tannin binding agents to interact with the tannins present in the wine (such as the polymeric tannins), for example by masking sites on the tannins that interact with lysozyme. In one example, the tannin binding agents are incubated with the mixture for at least 2 minutes, such as at least 5 minutes, at least 6 minutes, at least 10 minutes, at least 30 minutes or even at least 60 minutes, such as 2-120 minutes, 2-60 minutes, 5-60 minutes, or 2-30 minutes. Subsequently, lysozyme is added at a concentration to substantially inhibit microbial growth, such as at least 50 ppm.

In one example, grapes are harvested, and must is generated by extracting juice from the desired grapes using standard methods. For example, grapes can be chopped, crushed, pressed, boiled, soaked, or combinations thereof. The resulting must is then fermented using methods known in the art. For example, sugar, acid, nutrients, and yeast can be added to achieve the proper ratio. The resulting mixture is fermented, for example 3 to 10 days at 65-95° F. The presence of foaming indicates that the yeast are fermenting the must.

The fermentation mixture is clarified, for example by straining off the liquid from the pulp, and the liquid allowed to continue fermenting until it becomes completely clear (for example 4-6 weeks at 55-75° F. until bubbling ceases; this should take several weeks). A hydrometer can be used to confirm that the fermentation has completed. The hydrometer should read between 0.990 and 0.998 on the Specific Gravity scale.

After fermentation is completed, one or more tannin-binding agents are added to the resulting wine. For example, at least 600 ppm of pectin (final concentration in the wine) can be added to the fermented wine. Subsequently, lysozyme is added to the fermented wine, at a time when the one or more tannin-binding agents have significantly interacted with tannins present in the wine, such as the polymeric tannins present. For example, at least 500 ppm of lysozyme (final concentration in the wine) can be added to the fermented wine. The resulting wine that includes both the tannin-binding agent and the lysozyme can then be aged and bottled. In some examples, aging is performed in the bottle. In another example, aging is performed first in a barrel, prior to transfer to a bottle.

For example, when wine is clear and all fermentation has stopped, one or more tannin-binding agents and lysozyme are added to the wine, an the wine can be stored in a barrel or other container, for example siphoned into wine bottles and the bottles secured with a cork or other top. If transferred into bottles, the bottles are stored upright for 3-5 days and then on their side at 55° F., for example for at least six months (white wine) or for at least 1 year (red wine), or longer if desired.

In view of the many possible embodiments to which the principles of the disclosed invention may be applied, it should be recognized that the illustrated embodiments are only examples of the invention and should not be taken as limiting the scope of the invention. Rather, the scope of the invention is defined by the following claims. We therefore claim as our invention all that comes within the scope and spirit of these claims.

1. A method of decreasing an interaction between a tannin and lysozyme in wine, comprising:
introducing a tannin-binding agent into wine comprising a tannin under conditions sufficient for binding of the tannin-binding agent to the tannin; and
introducing lysozyme into the wine.

2. The method of claim 1, wherein the tannin-binding agent is introduced in an amount sufficient that the interaction between the tannin and the lysozyme is decreased by at least 25% as compared to interaction in the absence of the tannin-binding agent.

3. The method of claim 1, wherein the tannin-binding agent is introduced in an amount sufficient that the interaction between the tannin and the lysozyme is decreased by at least 50% as compared to interaction in the absence of the tannin-binding agent.

4. The method of claim 1, wherein the lysozyme is introduced in an amount of at least 50 mg lysozyme per L of wine.

5. The method of claim 1, wherein the lysozyme is introduced in an amount of at least 100 mg lysozyme per L of wine.

6.-7. (canceled)

8. The method of claim 1, wherein the tannin-binding agent is introduced in an amount of at least 50 mg tannin-binding agent per L of wine.

9. The method of claim 1, wherein the tannin-binding agent is introduced in an amount of at least 600 mg tannin-binding agent per L of wine.

10. (canceled)

11. The method of claim 1, wherein the tannin-binding agent comprises a polysaccharide, a protein, a carbohydrate, or combination thereof.

12.-13. (canceled)

14. The method of claim 11, wherein the pectin is introduced in an amount of at least 50 mg pectin per L of wine.

15. The method of claim 11, wherein the pectin is introduced in an amount of at least 600 mg pectin per L of wine.

16. The method of claim 11, wherein the protein comprises gelatin.

17. The method of claim 1, wherein decreasing an interaction between the tannin and the lysozyme increases an effective concentration of lysozyme in the wine, as compared to lysozyme effective concentration in the absence of the tannin-binding agent.

18. The method of claim 17, wherein the tannin-binding agent is provided in an amount sufficient that the effective concentration in the wine is increased by at least 50% as compared to lysozyme effective concentration in the wine in the absence of the tannin-binding agent.

19. The method of claim 1, wherein the tannin-binding agent is introduced into wine after fermentation.

20. The method of claim 1, wherein the lysozyme is introduced to the wine at least 5 minutes after introducing the tannin-binding agent into the wine.

21. A method of producing wine, comprising:
producing a must;
fermenting the must, thereby generating wine comprising a tannin;
introducing a tannin-binding agent into the wine under conditions sufficient to permit the tannin-binding agent to bind to at least a portion of tannin;
introducing lysozyme into the wine; and
allowing the wine to age.

22. The method of claim 21, wherein sulfur dioxide is not added to the wine.

23. A composition, comprising:
wine, wherein the wine comprises tannin;
a tannin-binding agent, bound to at least a portion of the tannin; and
lysozyme.

24. The composition of claim 23, wherein the lysozyme is present at a concentration of at least 50 mg lysozyme per L of wine.

25.-26. (canceled)

27. The composition of claim 23, wherein the tannin-binding agent is present at a concentration of at least 50 mg tannin-binding agent per L of wine prior to binding to at least a portion of the tannin.

28. (canceled)

29. The composition of claim 23, wherein the tannin-binding agent comprises a polysaccharide, a protein, a carbohydrate, or combination thereof.

30.-31. (canceled)

32. The composition of claim 29, wherein the composition comprises least 50 mg pectin per liter of wine.

33. (canceled)

34. The composition of claim 29, wherein the protein comprises gelatin.

35. The composition of claim 23, wherein the tannin-binding agent is present in a amount sufficient to bind sufficient tannin to increase effective concentration of the lysozyme by at least 50%, as compared to an absence of the tannin-binding agent in the composition.

36. A composition comprising:
wine, wherein the wine comprises a polymeric tannin;
at least 50 ppm lysozyme; and
at least 50 ppm pectin.

37. The composition of claim 36, comprising:
50 ppm to 500 ppm lysozyme; and
ppm to 1500 ppm pectin.
